(19) United States
(12) Patent Application Publication
(10) Pub. No.: US 2004/0118186 A1
(43) Pub. Date: Jun. 24, 2004

(54) Leak detecting device

(76) Inventor: John Shultis, Cottekill, NY (US)

Correspondence Address: JOHN MAIER, III, 666 AAROW COURT, KINGSTON, NY, 12401, US

(21) Appl. No.: 10/328,269

(22) Filed: Dec. 23, 2002

(51) Int. Cl. G01M 3/04

(52) U.S. Cl. 73/49.2

(57) ABSTRACT

A leak detecting device including a cylinder with a pressure gauge at one end and a female faucet connector at the other end to attach to a faucet in a water system to be tested. The cylinder further having a sniffer valve to inject a compressed gas into the water system. The pressure of the gas is shown on the pressure gauge. If the pressure does not drop after the passage of time, the water system is known to be free of leaks.

### BACKGROUND OF THE INVENTION

1. Field of the Invention

This invention relates to a device for the testing of a pipe system for leaks and, more particularly, to a device for testing for leaks in a domestic water system.

2. Prior Art and Objects

It has become an accepted practice under building codes to require the pressure testing of water systems of a new construction before permitting the water system to be connected to the available water supply. In order to satisfy the required test of the water system, now usually constructed of copper tubing with soldered fittings, the system must be filled with compressed air to a substantial pressure and then the pressure must be held for a reasonable period of time to assure that there are no leaks. The leak detecting device, in accordance with this invention, may be used with any water system, whether domestic or commercial.

This has caused plumbing contractors to undertake serious projects, including the installation of special sections, to seal the water system and inject a compressed gas, most usually air, into the system. The various approaches used cost time and money and may result in the creation of leaks.

In the prior art, various devices have been proposed, particularly for testing gas distribution systems. One such device is described in the Asbra Patent, U.S. Pat. No. 4,998,434. Asbra permanently places a test unit in the gas line, adjacent the inlet of a gas supply. A valve in the device permits the distribution system to be closed off from the supply source. A valve is located at the side of the device to introduce compressed air and a gauge is mounted on the device to show the pressure of the compresssedair introduced in to the system. The Asbra Patent teaches a device for checking gas distribution systems after an earthquake. For this reason, its permanent installation has a purpose but for the initial testing of a domestic water system prior to hookup to the supply source, such a device as contemplated by Asbra would be neither time or cost efficient.

The Alexander Patent, U.S. Pat. No. 5,548,993, which is also directed to testing gas service or distribution lines, proposes a removable device. A cap is provided for connection to a pipe rather to a faucet. Whether the cap is threaded is not disclosed by Alexander and possible a force fit is used by Alexander. The valve used to introduce a compressed gas into the system is also not clearly described. The device taught by Alexander is also cumbersome, being made from a collection of parts and does not have a single unit cylinder with the valve, gauge and cap directly connected to the single unit cylinder.

Usually, near the point of connection to the water supply, a shut off valve is located. By closing this valve, or in its absence, affixing a cap to the end of the pipe at the point where connection to the supply will ultimately occur, the water system is sealed. It is also commonplace for every home to have a pair of faucets for connection to hoses for supplying hot and cold water to a washing machine. Even in the absence of such faucets, an outside faucet is virtually assured. There are also other faucets that have threaded outlets for a hose connection within water systems, both domestic and commercial.

The device, which is the subject of this invention, is readily connected to any faucet which is threaded to permit the connection of a hose. The device, which is constructed about cylinder which is formed in one piece, includes a sniffer valve to permit the easy introduction of compressed gas through the faucet on which the leak detecting device is mounted which faucet, of course, must be open while the water system otherwise is closed. The pressure gauge shows the pressure in the water system. After introduction of the desired level of compressed gas, the sniffer valve closes and after the passage of time, the pressure gauge advises if the pressure drops indicating the presence of at least one leak in the system. However, if the pressure remains steady, a tight water system is assured. Upon completion of the test, the leak detecting device is removed from the faucet which is also one way to release the compressed gas. If release of the air pressure is desired prior to the removal of the device, any other faucet in the domestic water system may be opened and the pressure of the compressed air will quickly evacuate the domestic water system.

Therefore, it is an object of this invention to provide a device that can be readily connected to a system without alteration of the water system to introduce compressed gas to the domestic water system to determine if the pressure holds over a sufficient period of time to assure that there are no leaks in the water system.

It is a further object of this invention to provide a device which is compact and easily carried in a tool box.

It is still another object of this invention to provide a device which is durable and inexpensive.

These and other objects and advantages of the present invention will become apparent to those of ordinary skill in the art as the description thereof proceeds.

### SUMMARY OF THE INVENTION

A leak detecting device is provided for testing a water system. The leak detecting device is temporarily mounted on a faucet within the water system which has an outlet with a male thread for connecting to a hose. A cylinder has gauge end and a connector end and has a passageway through it from the gauge end to the connector end. A pressure gauge is mounted on the cylinder and is connected to the passageway. A means is mounted on the cylinder and connected to the passageway for injecting a compressed gas into the cylinder. A connector is mounted on the cylinder and is connected to the passageway and has a female thread for connecting to the male thread of a faucet.

### BRIEF DESCRIPTION OF THE DRAWINGS

FIG. 1 is a pictorial view of the Leak Detecting Device showing the faucet connector, the sniffer valve and the pressure gauge mounted on a one-piece cylinder.

FIG. 2 is an exploded view of the Leak Detecting Device showing each part separated from the other parts.

FIG. 3 is a pictorial view of the one-piece cylinder showing the three threaded openings in the cylinder.

FIG. 4 is a cross-sectional view of the cylinder showing the inner passage and all three threaded openings.

FIG. 5 is a pictorial view of the nut and connector showing the femal thread on the nut.

FIG. 6 is a cross sectional view along line 6-6 of FIG. 5.

FIG. 7 is a plan view of the Leak Detecting Device mounted on a faucet within a water system.

### DESCRIPTION OF THE NUMERALS

| NUMERAL | DESCRIPTION |
|---|---|
| 11 | Cylinder |
| 13 | Passageway |
| 15 | Gauge End |
| 17 | Female Thread |
| 19 | Connector End |
| 21 | Male Thread |
| 23 | Outside Surface |
| 25 | Side Opening |
| 26 | Female Thread |
| 27 | Sniffer Valve |
| 28 | Male Thread |
| 29 | Needle |
| 31 | Open End |
| 33 | Pressure Gauge |
| 35 | Male Thread |
| 37 | Nut |
| 39 | Sleeve |
| 41 | Flange |
| 43 | Connector |
| 44 | Female Hose Thread |
| 45 | Faucet |
| 47 | Threaded Outlet |
| 49 | Hose Washer |
| 51 | Domestic Water System |

### DETAILED DESCRIPTION OF THE PREFERRED EMBODIMENT

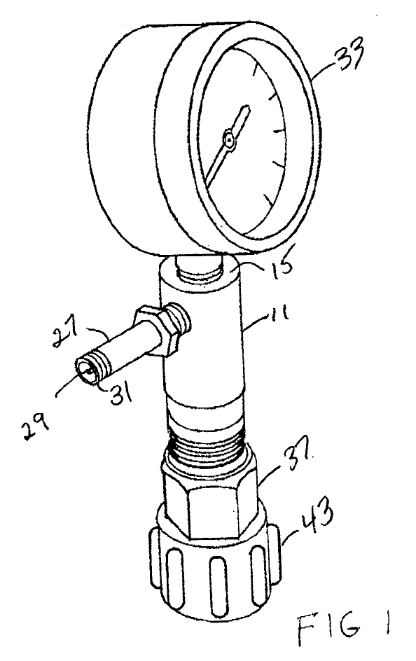

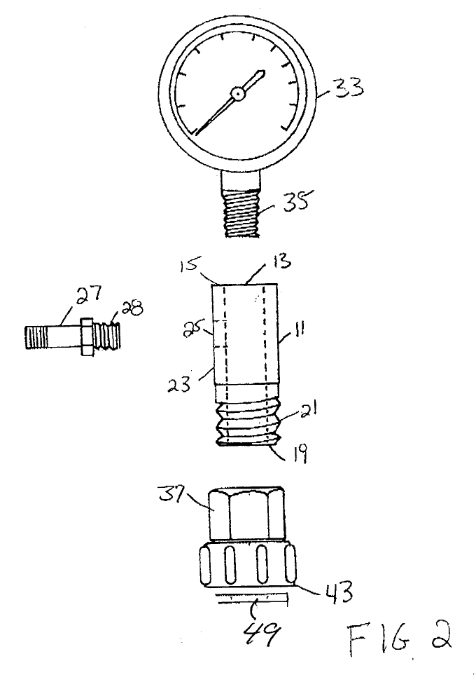

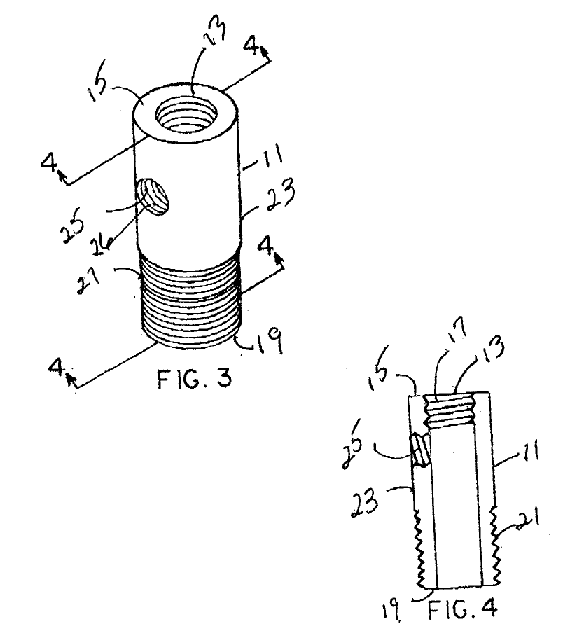

Referring now to FIG. 1, the leak detecting device is shown. The leak detecting device has an passageway which is generally concentrically located in the cylinder 11. The cylinder 11 which is made in one-piece has a gauge end 15 with a female thread 17 and a connector end 19 with a male thread 19. The cylinder 11 has an outside surface 23 and a side opening 25 which extends from the outside surface into the passageway 13. The side opening 25 is located substantially at right angles to the cylinder 11 and the passageway 13 is preferably located at a point on the cylinder toward the gauge end 15. The side opening 25 has a female thread 26.

In the side opening 25, a sniffer valve 27 is located 25. The sniffer valve 27 has a male thread 28 which engages the female thread 26 in the side opening. As best seen in FIG. 1, the sniffer valve 27 has a needle 29 which is depressed to permit compressed air to enter the leak detecting device through the sniffer valve. Upon removal of the source of compressed air (not shown), the needle 29 moves toward the open end 31 of the sniffer valve 27 to close the sniffer valve 27 to prevent the compressed air form escaping. The sniffer valve 27 is essentially the well-known valve used on automobile and truck tires for inflation purposes.

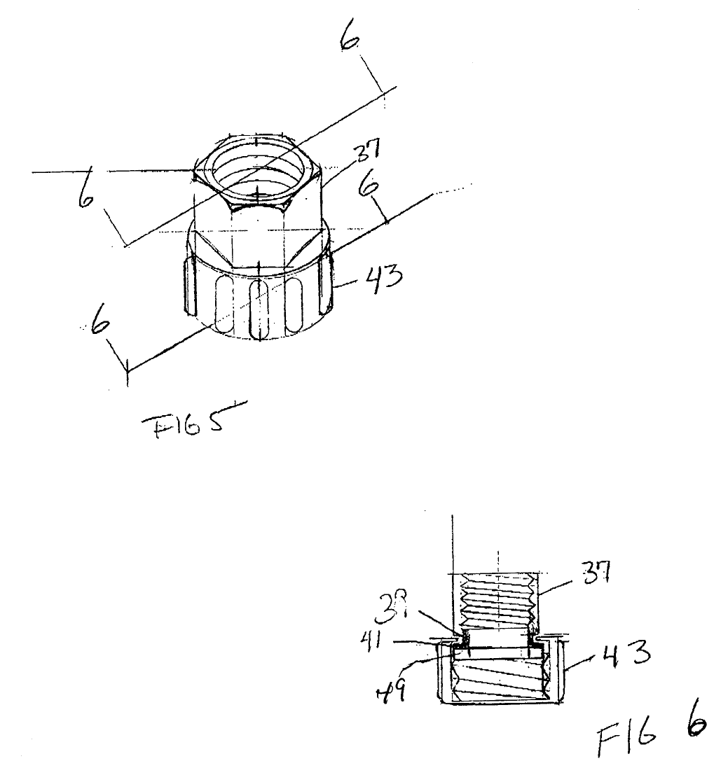

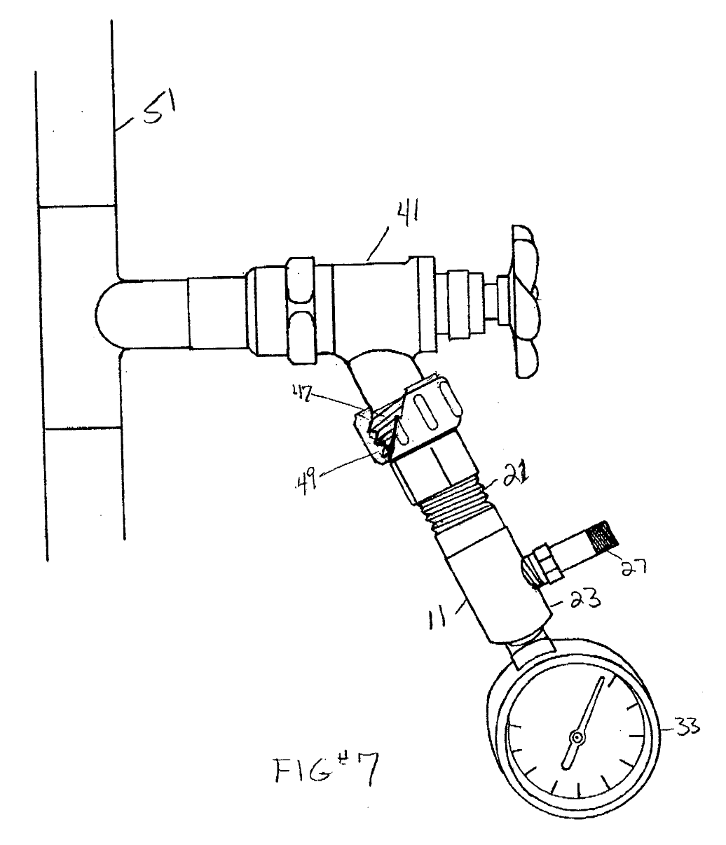

At the gauge end 15 of the cylinder 11, a pressure gauge 33, which has a male thread 35, is connected to the cylinder 11 by threading the male thread 35 of the pressure gauge 33 into the female thread 17 at the gauge end 15. A nut 37 is affixed to the connector end 19 of the cylinder 11. From the nut 37 there extends for a very short distance a sleeve 39 which is connected to a flange 41. Mounted to rotate on the sleeve is a connector 43. The flange 41 rests against the inside of the connector 43. The connector 43 has a female hose thread 44 constructed to fit upon a faucet 45 with a threaded outlet 47. A hose washer 49 is placed in the connector 43 against the flange 41 which is compressed when the connector 43 is threaded onto a faucet 45 as shown in FIG. 5.

In operation, a water system 51 is sealed for pressure testing. A faucet 45 is opened to provide access to the water system 51. The connector 43 is threaded onto the faucet 45 so as to provide a tight, leak-proof connection. Compressed air is introduced through the sniffer valve 27 until the pressure gauge 33 reads a suitable level of pressure desired for testing. After the passage of time, assuming no leaks to exist which would release the pressure, the pressure in the system can be released by opening the connector 43 or the pressure may be released by opening any other faucet in the domestic water system 51 being tested.

The Leak Detecting Device is light and compact. It can be conveniently stored in a tool box and used repeatedly.

It is to be understood that the drawings and descriptive matter in all cases to be interpreted as merely illustrative of the principles of the invention, rather than as limiting the same in any way, since it is contemplated that various changes may be made in various elements to achieve like results without departing from the spirit of the invention or the scope of the appended claims.

1. A leak detecting device for testing a water system which leak detecting device is temporarily mounted on a faucet within the water system which has an outlet with a male thread for connecting to a hose, such leak detecting device comprising:
a cylinder having gauge end and a connector end and having a passageway through it from the gauge end to the connector end;
a pressure gauge mounted on the cylinder and connected to the passageway;
means mounted on the cylinder and connected to the passageway for injecting a compressed gas into the cylinder; and
a connector mounted on the cylinder and connected to the passageway and having a female thread for connecting to the male thread of a faucet.

2. A leak detecting device according to claim 1 wherein the cylinder is in one piece.

3. A leak detecting device according to claim 1 wherein:
the cylinder has an outside surface;
a female thread located at the gauge end and a male thread located at the connector end, the cylinder further having a side opening in the outside surface, a female thread being located in the side opening.

4. A leak detecting device according to claim 1 wherein the means mounted on the cylinder for injecting a compressed gas into the cylinder is a sniffer valve.

5. A leak detecting device according to claim 1 wherein the cylinder has a female thread at the gauge end, the pressure gauge being mounted on the cylinder in the female thread at the gauge end.

6. A leak detecting device according to claim 1 wherein:
the cylinder has a male thread at the connector end; and
a nut is mounted on the male thread at the connector end, the connector being mounted to rotate on the nut.

7. A leak detector according to claim 1 wherein:
the cylinder has a side opening, the side opening being generally at a right angle to the passageway; and
the means mounted on the cylinder for injecting a compressed gas is a sniffer valve and the sniffer valve is mounted in the side opening.

8. A leak detecting device for testing a water system which leak detecting device is temporarily mounted on a faucet within the water system which has an outlet with a male thread for connecting to a hose, such leak detecting device comprising:
a cylinder having a gauge end and a connector end and having a passageway through it from the passageway through it from the gauge end to the connector end, the cylinder further having a side opening;
a sniffer valve mounted in the side opening;
a pressure gauge mounted at the gauge end;
a nut mounted on the connector end of the cylinder; and
a connector mounted to rotate on the nut;

9. A leak detecting device according to claim 8 wherein the cylinder is in one piece.

10. A leak detecting device according to claim 8 wherein the cylinder has an outside surface and a female thread at the gauge end and a male thread at the connector end, the side opening extending from the outside surface to the passageway.

11. A leak detecting device according to claim 8 wherein:
the cylinder has a male thread at the connector end; and
a nut is mounted on the male thread at the connector end, the connector being mounted to rotate on the nut.

12. A leak detecting device for testing a water system which leak detecting device is temporarily mounted on a faucet within the water system which has an outlet with a male thread for connecting to a hose, such leak detecting device comprising:
a cylinder having an outside surface and a gauge end and a connector end and having a passageway generally concentrically located through it from the gauge end to the connector end, a female thread being located at the gauge end and a male thread being located at the connector end, the cylinder further having a side opening located generally at right angles to the passageway extending from the outside surface to the passageway, a female thread being located in the side opening;
a sniffer valve mounted in the side opening;
a pressure gauge mounted in the female thread at the gauge end;
a nut mounted on the male thread at the connector end, a sleeve extending from the nut;
a connector mounted to rotate on the sleeve and having a female thread adapted to mate with the thread of a faucet, a flange extending from the sleeve to retain the connector on the sleeve; and
a washer located within the connector and against the flange.

13. A leak detecting device according to claim 12 wherein the cylinder is in one piece.

14. A leak detecting device according to claim 12 wherein the side opening is located in the cylinder toward the gauge end.
